(19) United States
(12) Patent Application Publication
(10) Pub. No.: US 2019/0016397 A1
(43) Pub. Date: Jan. 17, 2019

(54) ROW-CROP TRACTOR

(71) Applicant: Frank Rempel, Swift Current (CA)

(72) Inventor: Frank Rempel, Swift Current (CA)

(21) Appl. No.: 15/843,276

(22) Filed: Dec. 15, 2017

(30) Foreign Application Priority Data
Jul. 14, 2017 (CA) 2973573

(51) Int. Cl. B62D 49/06; B62D 11/06; A01B 51/02; B62D 61/06

(52) U.S. Cl. CPC B62D 49/06; B62D 11/06; B62D 49/0678; A01B 49/02; B62D 61/065; B62D 49/0607; A01B 51/026

(57) ABSTRACT

A row-crop tractor including a tractor frame structure having a front portion and a rear portion. Two front wheels are rotatable mounted to the front portion of the tractor frame structure. At least a rear wheel is mounted to the rear portion of the tractor frame structure. A drive mechanism is mounted to the front portion of the tractor frame structure and connected to the two front wheels for controllably driving the same in dependence upon a control signal received from an operator of the row-crop tractor such that one front wheel is driven independent from the other. A front farm implement connecting mechanism is disposed at a front end of the front portion of the tractor frame structure and an operator seat mounted to the front portion of the tractor frame structure in close proximity to the front end of the front portion of the tractor frame structure such that the operator of the row-crop tractor is enabled to reach a front farm implement connected to the front farm implement connecting mechanism.

This application claims priority to Canadian Patent Application No. 2,973,573 filed on Jul. 14, 2017 and entitled ROW-CROP TRACTOR, the entire contents of which are hereby incorporated by reference.

### FIELD

The present disclosure relates to an agricultural tractor, and more particularly to a row-crop tractor that is highly maneuverable and enables employment of different farm implements for cultivating row-crops.

### BACKGROUND

With increasing demand in local and/or organic produce there is a substantial increase in the number of people growing produce for supplying their family and friends, and/or for selling the produce in local stores or farmers' markets. Typically, the produce—called crop hereinafter—is grown in rows on relatively small areas such as small fields and gardens and comprises, for example, potatoes, carrots, lettuce, and various other types of vegetables.

Modern, large scale farming has long employed highly sophisticated tractors and farm implements for various farming operations such as, for example, tilling, planting, and fertilizing, executed on large agricultural fields. Unfortunately, while some of the farm implements are adaptable for small scale applications, for example, for being mounted to a small standard type tractor such as a garden tractor, their application with such a small standard type tractor for cultivating row-crops on relatively small areas is awkward and inconvenient at best. In particular, vegetable and potato planting is not possible because the operator cannot reach the planter for handling and control, crops cannot be cultivated to full growth, and a substantial portion of the garden/field has to be used for turning the tractor and, therefore, cannot be cultivated.

It may be desirable to provide a row-crop tractor that is highly maneuverable for enabling cultivating of end zones of gardens and small fields.

It also may be desirable to provide a row-crop tractor that has sufficient clearance to ground for enabling cultivation of row-crops to full growth.

It also may be desirable to provide a row-crop tractor that enables mounting of a planter to a front end thereof and handling/controlling of the same from an operator seat of the row-crop tractor.

It also may be desirable to provide a row-crop tractor that enables mounting of a farm implement in front of the operator as well as behind the operator of the row-crop tractor.

### SUMMARY

Accordingly, one object is to provide a row-crop tractor that is highly maneuverable for enabling cultivating of end zones of gardens and small fields.

Another object is to provide a row-crop tractor that has sufficient clearance to ground for enabling cultivation of row-crops to full growth.

Another object is to provide a row-crop tractor that enables mounting of a planter to a front end thereof and handling/controlling of the same from an operator seat of the row-crop tractor.

Another object is to provide a row-crop tractor that enables mounting of a farm implement in front of the operator as well as behind the operator of the row-crop tractor.

According to one aspect, there is provided a row-crop tractor. The row-crop tractor comprises a tractor frame structure having a front portion and a rear portion. Two front wheels are rotatable mounted to the front portion of the tractor frame structure. At least a rear wheel is mounted to the rear portion of the tractor frame structure. A drive mechanism is mounted to the front portion of the tractor frame structure and connected to the two front wheels for controllably driving the same in dependence upon a control signal received from an operator of the row-crop tractor. A front farm implement connecting mechanism is disposed at a front end of the front portion of the tractor frame structure and an operator seat mounted to the front portion of the tractor frame structure.

According to one aspect, there is provided a row-crop tractor. The row-crop tractor comprises a tractor frame structure having a front portion and a rear portion. Two front wheels are rotatable mounted to the front portion of the tractor frame structure. At least a rear wheel is mounted to the rear portion of the tractor frame structure. A drive mechanism is mounted to the front portion of the tractor frame structure and connected to the two front wheels for controllably driving the same in dependence upon a control signal received from an operator of the row-crop tractor such that one front wheel is driven independent from the other. A front farm implement connecting mechanism is disposed at a front end of the front portion of the tractor frame structure and an operator seat mounted to the front portion of the tractor frame structure in close proximity to the front end of the front portion of the tractor frame structure such that the operator of the row-crop tractor is enabled to reach a front farm implement connected to the front farm implement connecting mechanism.

According to one aspect, there is provided a row-crop tractor. The row-crop tractor comprises a tractor frame structure having a front portion and a rear portion. Two front wheels are rotatable mounted to the front portion of the tractor frame structure. At least a rear wheel is mounted to the rear portion of the tractor frame structure. A rear farm implement connecting mechanism is disposed at a rear end of the front portion of the tractor frame structure such that a farm implement when connected thereto is placed between the front wheels and the at least a rear wheel. A drive mechanism is mounted to the front portion of the tractor frame structure and connected to the two front wheels for controllably driving the same in dependence upon a control signal received from an operator of the row-crop tractor, the drive mechanism being adapted for driving one front wheel independent from the other.

One advantage of the disclosed tractor is that it provides a row-crop tractor that is highly maneuverable for enabling cultivating of end zones of gardens and small fields.

A further advantage of the disclosed tractor is that it provides a row-crop tractor that has sufficient clearance to ground for enabling cultivation of row-crops to full growth.

A further advantage of the disclosed tractor is to provide a row-crop tractor that enables mounting of a planter to a front end thereof and handling/controlling of the same from an operator seat of the row-crop tractor.

A further advantage of the disclosed tractor is to provide a row-crop tractor that enables mounting of a farm implement in front of the operator as well as behind the operator of the row-crop tractor.

### BRIEF DESCRIPTION OF THE DRAWINGS

An embodiment of the present invention is described below with reference to the accompanying drawings, in which:

FIGS. 1a to 1c are simplified block diagrams illustrating in a side view, a top view, and a front view, respectively, a row-crop tractor according to one embodiment of the invention;

FIGS. 1d and 1e are simplified block diagrams illustrating in cross-sectional views mounting of a front wheel to a respective wheel mount of the a side view and a perspective view, respectively, of the row-crop tractor according to one embodiment of the invention;

FIG. 2 is a simplified block diagram illustrating in a top view the row-crop tractor according to one embodiment of the invention during a U-turn; and,

FIGS. 3a and 3b are simplified block diagrams illustrating in a perspective view and a front view, respectively, an implementation of the row-crop tractor according to one embodiment.

### DETAILED DESCRIPTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, certain methods and materials are now described.

While the description of certain embodiments hereinbelow is with reference to a row-crop tractor for cultivating small fields and gardens, it will become evident to those skilled in the art that the embodiments of the invention are not limited thereto, but can be up-scaled for cultivation of larger size agricultural land.

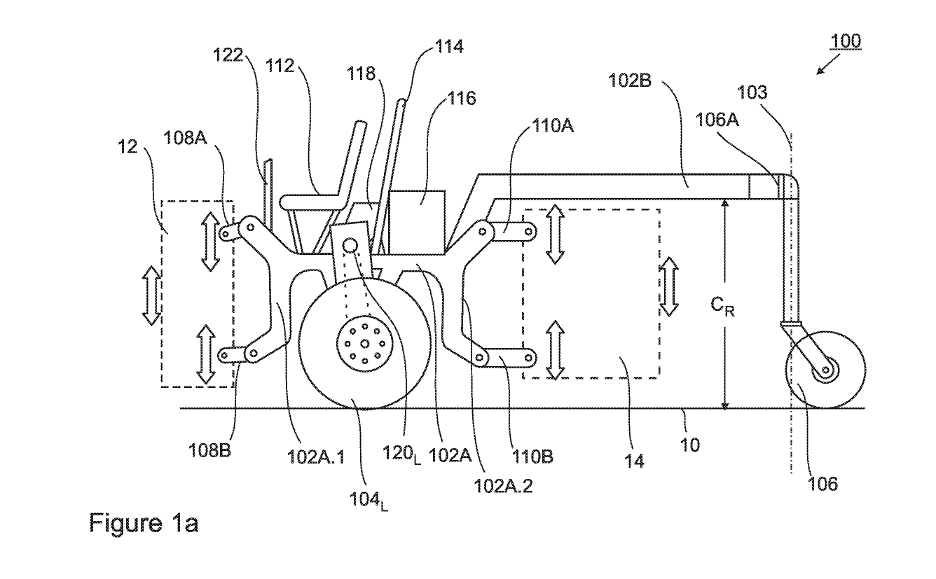

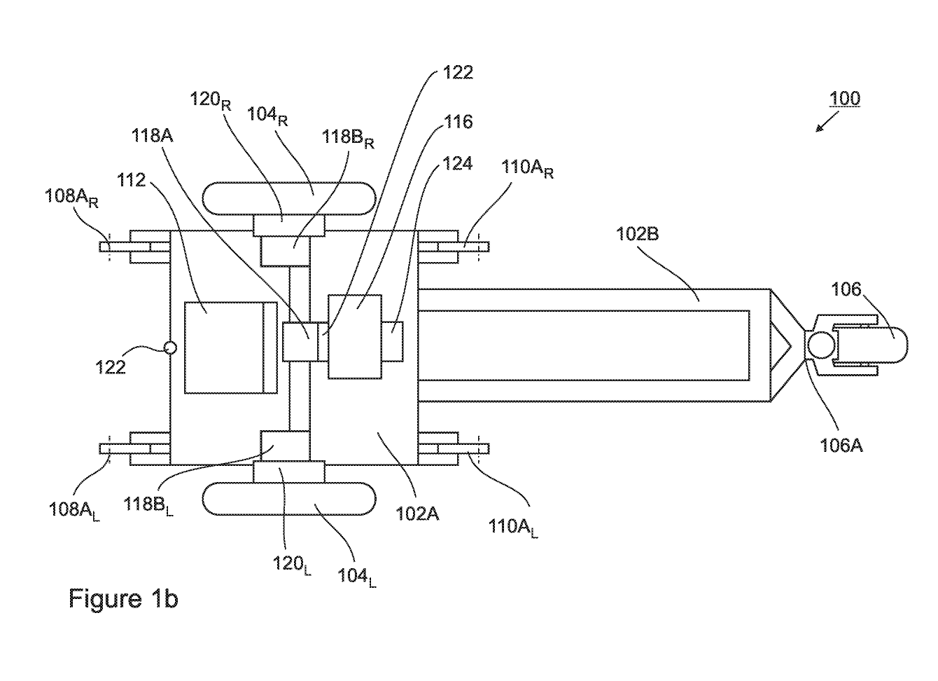

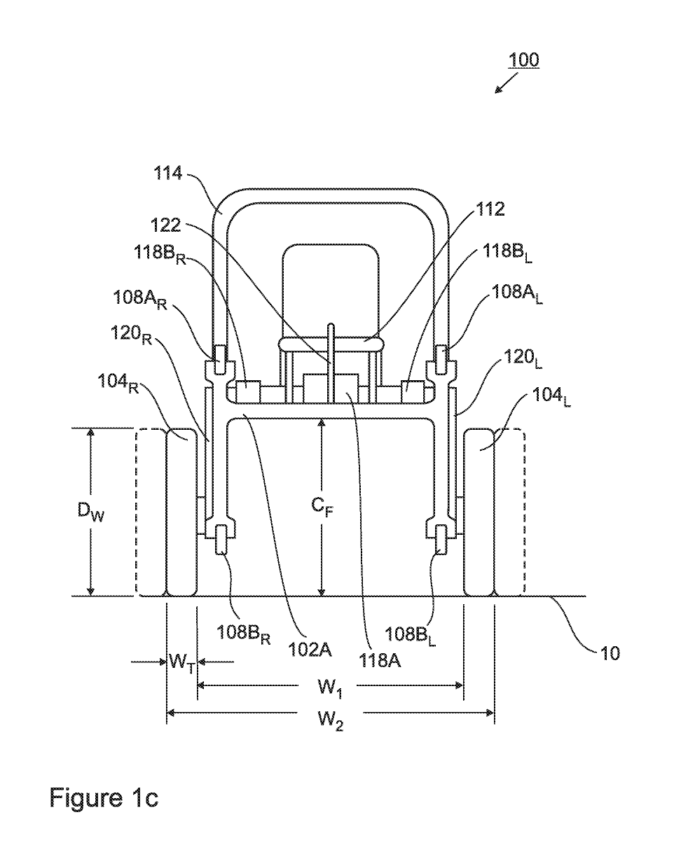

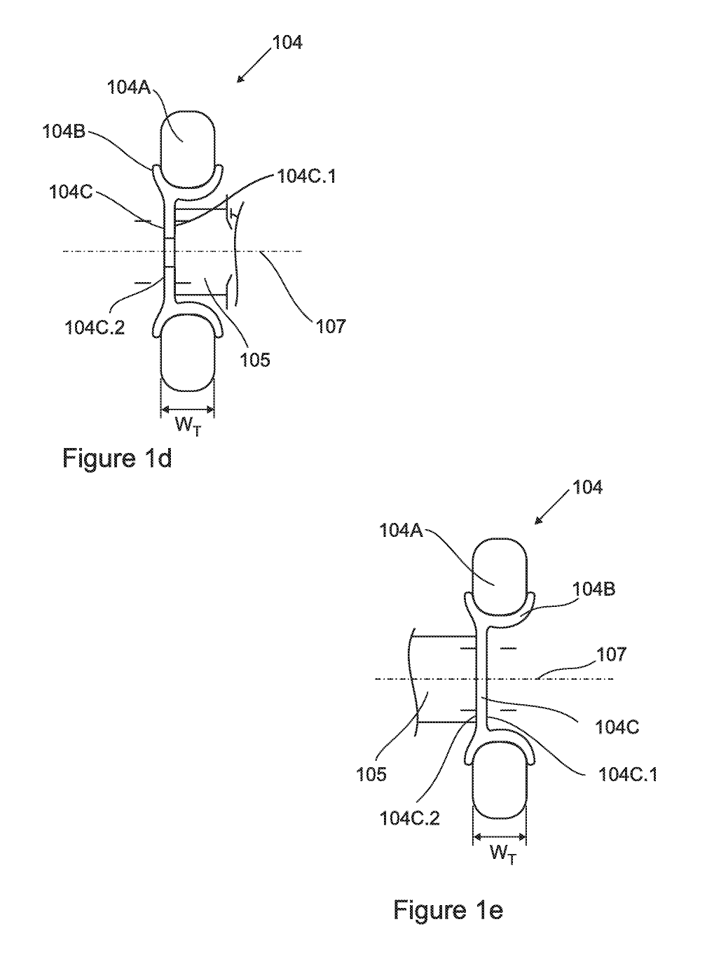

Referring to FIGS. 1a to 1e, a row-crop tractor 100 according to one embodiment of the invention is provided. The row-crop tractor 100 comprises a tractor frame structure having a front portion 102A and a rear portion 102B. A left hand side front wheel 104_{L} and a right hand side front wheel 104_{R} are rotatable mounted to the front portion 102A of the tractor frame structure. At least a rear wheel 106 is mounted to the rear portion 102B of the tractor frame structure. The tractor frame structure is made of, for example, steel components manufactured using standard technology such as molding and forging and assembled using standard fastening techniques such as welding, riveting, and screw fastening. The rear portion 102B can be provided as a beam structure extending from the front portion 102A rearwardly, as illustrated in FIGS. 1a and 1b. The rear wheel 106 can be of conventional castor wheel design, able to swivel about substantially vertically oriented axis 103, and removable/re-attachable mounted to the rear end of the beam structure via rear wheel connecting structure 106A using, for example, matching connecting plates and screw bolts. Alternatively, the rear portion 102B may be adapted for mounting more than a single rear wheel thereto. The front wheels 104_{L} and 104_{R} are each mounted the front portion 102A, for example, via a respective axle comprising wheel mount 105 with the axle mounted to the front portion 102A using conventional bearings.

A drive mechanism is mounted to the front portion 102A of the tractor frame structure and connected to the two front wheels 104_{L}, 104_{R} for controllably driving the same in dependence upon a control signal received from an operator of the row-crop tractor via controls 122. The drive mechanism can comprise an internal combustion engine such as, for example, a commercially available two-stroke or four-stroke gasoline engine 116 connected to a transmission 118A, 118B via belt driven clutch 122. The engine 116 can be placed at the rear of the front portion 102A of the tractor frame structure. Alternatively, other types of engines may be employed such other types of internal combustion engines such as, for example, a Diesel engine, or a battery powered electric motor. The drive mechanism can further comprise a commercially available hydrostatic transmission with hydraulic pump 118A—driven by the engine 116 via the clutch 122—and left hand side and right hand side hydraulic motors 118B_{L}, 118B_{R} connected thereto. The front wheels 104_{L}, 104_{R} are then driven by the respective hydraulic motors 118B_{L}, 118B_{R} connected thereto via respective conventional sprocket drives 120_{L}, 120_{R}. Alternatively, the sprocket drives 120_{L}, 120_{R} are omitted by disposing the hydraulic motors 118B_{L}, 118B_{R} in the respective wheel mounts 105. In dependence upon a control signal received from an operator of the row-crop tractor via controls 122 the hydrostatic transmission drives the front wheels 104_{L}, 104_{R} independent from each other—for example, such that: the front wheels 104_{L}, 104_{R} are driven at a different speed; one of the front wheels 104_{L}, 104_{R} is driven while the other is at rest; and, optionally, the front wheels 104_{L}, 104_{R} are driven in a different direction—for enabling steering of the row-crop tractor 100. While employment of the hydrostatic transmission provides a relatively simple design and high maneuverability, other types of transmission and steering may also be employed such as, for example, standard gear mechanism and standard steering mechanism for orienting the front wheels and/or rear the rear wheel into a desired direction.

The row-crop tractor 100 can comprise a front farm implement connecting mechanism—comprising power lift arms 108A_{L}, 108A_{R} and control arms 108B_{L}, 108B_{R}—disposed at a front end 102A.1 of the front portion 102A of the tractor frame structure as well as a rear farm implement connecting mechanism—comprising power lift arms 110A_{L}, 110A_{R} and control arms 110B_{L}, 110B_{R}—disposed at a rear end 102A.2 of the front portion 102A of the tractor frame structure. The power lift arms are pivotally movable in order to vertically adjust the position of the front farm implement 12 and the rear farm implement 14 connected thereto, as indicated by the block arrows in FIG. 1a, and are driven using hydraulic cylinders powered, for example, by an electric driven hydraulic pump with the electric power provided by electric generator 124 connected to the engine 116. Alternatively, the power lift arms are actuated using electric actuators. Optionally, the front and rear farm implement connecting mechanisms also comprise conventional power-take-offs for driving the respective farm implements.

Operator seat 112 is mounted to the front portion 102A of the tractor frame structure, in one case, placed in close proximity to the front end 102A.1 of the front portion 102A of the tractor frame structure such that the operator of the row-crop tractor is enabled to reach the front farm implement 12 connected to the front farm implement connecting mechanism 108A, 108B—for example, while being seated in the operator seat and bending forward. Placing the operator seat in close proximity to the front end 102A.1 enables the operator, for example, to handle/control a planter such as a manually operated potato planter while also controlling the row-crop tractor 100. The operator seat 112 is, for example, a commercially available seat comprising means for adjusting the same to the operator's body size and seating preferences. For operator safety, a conventional roll-over-protection 114 is mounted to the front portion 102A. Of course further devices for protecting the operator such as, for example, a roof, may also be mounted to the front portion 102A.

Various types of farm implements 12, 14 can be connected to the front and rear farm implement connecting mechanisms of the row-crop tractor 100 such as, for example, rototillers, planters, and harvesters.

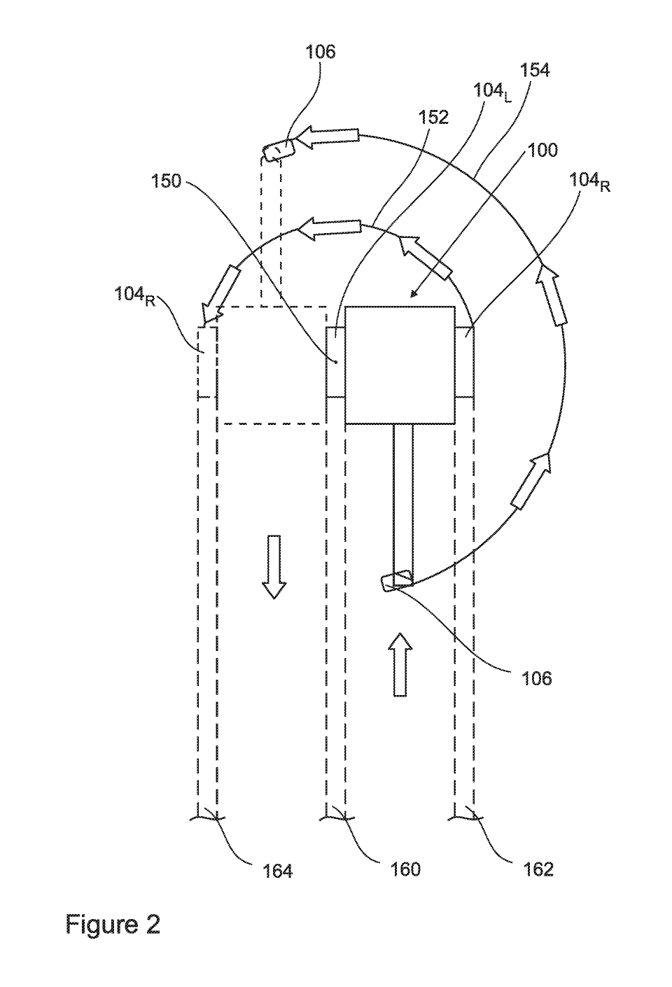

It is noted that the hydrostatic transmission driving one of the front wheels 104_{L}, 104_{R} while the other is at rest enables the row-crop tractor 100 to perform a U-turn where the left front wheel 104_{L} is at rest while the right front wheel 104_{R} and the rear wheel 106 follow circles 152 and 154, respectively, as indicated by the block arrows in FIG. 2, resulting in the left front wheel 104_{L} following the same track 160 while the right front wheel 104_{R} changes from track 162 to track 164. The U-turn illustrated in FIG. 2 substantially facilitates cultivation of row-crops on small areas by minimizing the space needed for turning the row-crop tractor 100 and enabling substantially accurate following of tracks 160, 162, and 164 between the crop rows.

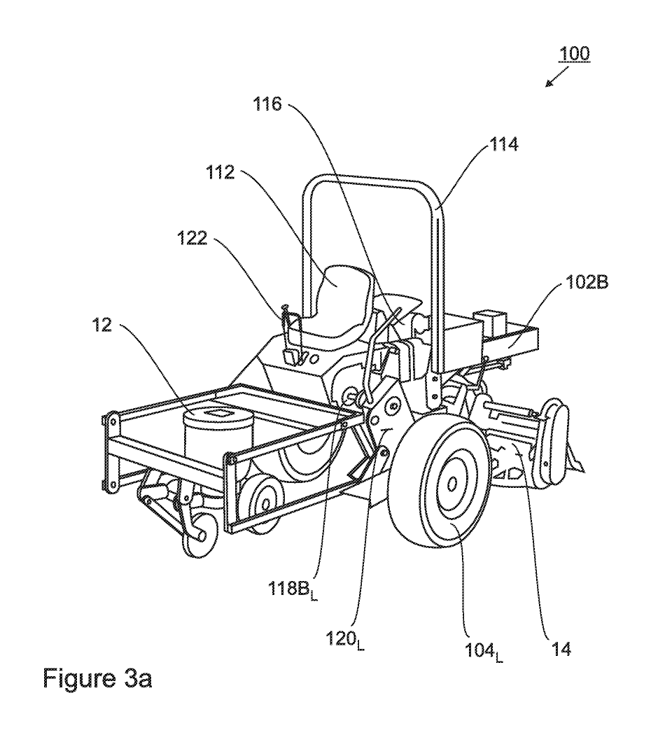

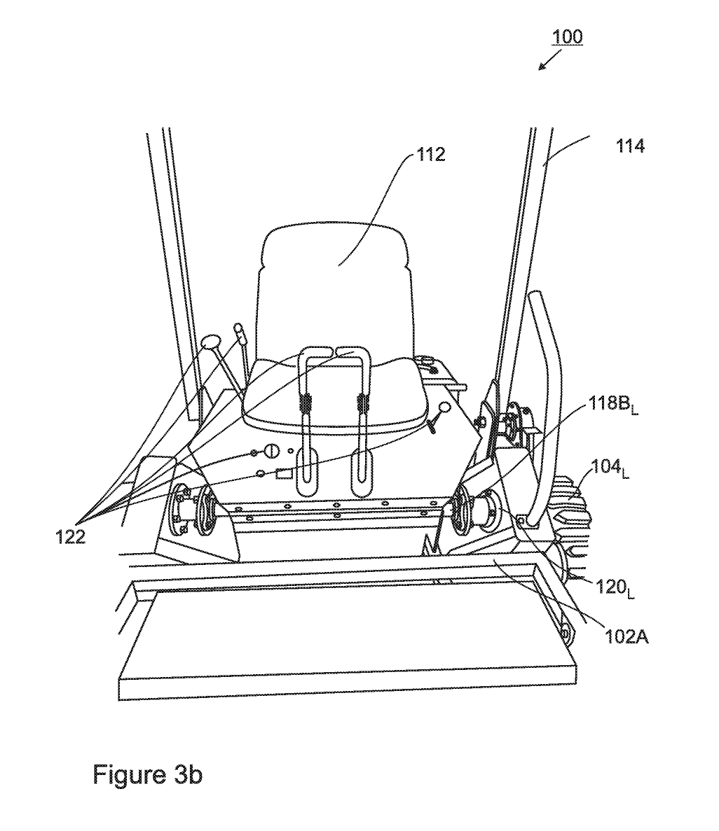

It is further noted that the removable mounting of the rear wheel 106 enables use of the row-crop tractor 100 without the rear wheel 106 when at least one of the front farm implement 12 and the rear farm implement 14 is connected thereto and is capable of providing a third point of support to ground 10, as illustrated in FIG. 3a, thus preventing an imprint of the rear wheel 106 in the crop row.

The front portion 102A of the tractor frame structure is designed such that there is sufficient clearance C_{F} to ground 10, as illustrated in FIG. 1c, for cultivating row-crops to full growth, for example, for weed control. The rear portion 102B of the tractor frame structure has sufficient clearance C_{R} to ground 10, as illustrated in FIG. 1a, for accommodating a rear farm implement connected to the rear farm implement connecting mechanism 110A, 110B between the rear portion 102B of the tractor frame structure and the ground 10.

A distance W₁, W₂ between the front wheels 104_{L}, 104_{R} can be adjustable for cultivating crop rows having different widths. For example, tire 104A is mounted to wheel rim 104B with wheel hub 104C being placed on one side of the wheel rim 104A in a direction along the axis of rotation 107 of the wheel, enabling changing of the distance W₁, W₂ by approximately twice the width W_{T} of the tire by mounting either wheel hub surface 104C.1 or 104C.2 to the wheel mount 105, as illustrated in FIGS. 1d and 1e. Other widths W₁, W₂ may be achieved by placing the wheel hub differently with respect to the wheel rim, or by providing an adjustment element interposed between the wheel hub 104C and the wheel mount 105.

The control system for controlling the various components of the row-crop tractor 100 such as, for example, the engine 116, the hydrostatic transmission 118A, 118B, and the power lift arms 108A, 110A via conventional controls 122 is implemented, for example, using Controller Area Network (CAN) Bus technology with an off-the-shelf automotive Programmable Logic Controller (PLC) for executing executable commands which can be stored in non-volatile memory such as, for example, flash-memory.

In an example implementation illustrated in FIGS. 3a and 3b, the row-crop tractor 100 has: a front clearance C_{F} of approximately 70 cm, a rear clearance C_{R} of approximately 90 cm, a width W₁ of approximately 180 cm, front wheel 104 diameter D_{W} of approximately 85 cm, front and rear wheel tire width W_{T} of approximately 30 cm, and is driven using a 20 KW four-stroke gasoline engine.

The present invention has been described herein with regard to certain embodiments. However, it will be obvious to persons skilled in the art that a number of variations and modifications can be made without departing from the scope of the invention as described herein.

What is claimed is:

1. A row-crop tractor comprising:
a tractor frame structure having a front portion and a rear portion;
two front wheels rotatable mounted to the front portion of the tractor frame structure;
at least a rear wheel mounted to the rear portion of the tractor frame structure;
a drive mechanism mounted to the front portion of the tractor frame structure and connected to the two front wheels for controllably driving the same in dependence upon a control signal received from an operator of the row-crop tractor;
a front farm implement connecting mechanism disposed at a front end of the front portion of the tractor frame structure; and,
an operator seat mounted to the front portion of the tractor frame structure.

2. The row-crop tractor according to claim 1 wherein the operator seat is placed in close proximity to the front end of the front portion of the tractor frame structure such that the operator of the row-crop tractor is enabled to reach a front farm implement connected to the front farm implement connecting mechanism.

3. The row-crop tractor according to claim 1 wherein the drive mechanism is adapted for driving one front wheel independent from the other.

4. The row-crop tractor according to claim 3 wherein the drive mechanism is adapted for driving one front wheel while the other is at rest.

5. The row-crop tractor according to claim 3 wherein the drive mechanism comprises a hydrostatic transmission.

6. The row-crop tractor according to claim 1 wherein the tractor frame structure has sufficient clearance to ground for cultivating crops to full growth.

7. The row-crop tractor according to claim 1 wherein the drive mechanism comprises an engine placed between the operator seat and a rear end of the front portion of the tractor frame structure.

8. The row-crop tractor according to claim 1 wherein the at least a rear wheel comprises a single swivel wheel.

9. The row-crop tractor according to claim 1 comprising a rear farm implement connecting mechanism disposed at a rear end of the front portion of the tractor frame structure.

10. The row-crop tractor according to claim 9 wherein the rear portion of the tractor frame structure has sufficient clearance to ground for accommodating a rear farm implement connected to the rear farm implement connecting mechanism between the tractor frame structure and the ground.

11. The row-crop tractor according to claim 1 wherein a distance between the two front wheels is adjustable.

12. The row-crop tractor according to claim 11 wherein each of the two front wheels comprises a hub and a rim and wherein the hub is placed a predetermined distance from a center of the rim in a direction along an axis of rotation of the two front wheels.

13. The row-crop tractor according to claim 1 wherein the at least a rear wheel is removable mounted to the rear portion of the tractor frame structure, wherein a front farm implement is connected to the front farm implement connecting mechanism, and wherein the row-crop tractor is operable with the rear wheel being removed.

14. A row-crop tractor comprising:
a tractor frame structure having a front portion and a rear portion;
two front wheels rotatable mounted to the front portion of the tractor frame structure;
at least a rear wheel mounted to the rear portion of the tractor frame structure;
a rear farm implement connecting mechanism disposed at a rear end of the front portion of the tractor frame structure such that a farm implement when connected thereto is placed between the front wheels and the at least a rear wheel; and,
a drive mechanism mounted to the front portion of the tractor frame structure and connected to the two front wheels for controllably driving the same in dependence upon a control signal received from an operator of the row-crop tractor, the drive mechanism being adapted for driving one front wheel independent from the other.

15. The row-crop tractor according to claim 14 wherein the rear portion of the tractor frame structure has sufficient clearance to ground for accommodating a rear farm implement connected to the rear farm implement connecting mechanism between the tractor frame structure and the ground.

16. The row-crop tractor according to claim 14 comprising a front farm implement connecting mechanism disposed at a front end of the front portion of the tractor frame structure.

17. The row-crop tractor according to claim 14 wherein the drive mechanism is adapted for driving one front wheel while the other is at rest.

18. The row-crop tractor according to claim 14 wherein the at least a rear wheel comprises a single swivel wheel.

19. The row-crop tractor according to claim 14 wherein a distance between the two front wheels is adjustable.

20. The row-crop tractor according to claim 14 wherein the at least a rear wheel is removable mounted to the rear portion of the tractor frame structure, wherein a rear farm implement is connected to the rear farm implement connecting mechanism, and wherein the row-crop tractor is operable with the rear wheel being removed.
